(19) United States
(12) Patent Application Publication
(10) Pub. No.: US 2017/0197994 A1
(43) Pub. Date: Jul. 13, 2017

(54) METHOD FOR RECOVERY OF IONIC LIQUID AND SYSTEM THEREOF

(71) Applicant: Reliance Industries Limited, Mumbai (IN)

(72) Inventors: Akhilesh YADAV, Mumbai (IN); Parasuveera UPPARA, Mumbai (IN); Pavan Kumar ADURI, Mumbai (IN); Viswanath KOTRA, Hyderabad (IN); Vibhuti DUKHANDE, Mumbai (IN)

(21) Appl. No.: 15/325,038

(22) PCT Filed: Jul. 8, 2015
(86) PCT No.: PCT/IB15/55167

§ 371 Date: Jan. 9, 2017

(30) Foreign Application Priority Data
Jul. 9, 2014 (IN) 2244/MUM/2014

(51) Int. Cl. C07F 5/06; B01J 31/40; B01J 35/12; B01J 38/56; B01D 3/14; B01D 1/26; B01D 29/94; B01D 29/92; B01D 35/00; B01D 1/06; B01J 31/02; B01J 38/02

(52) U.S. Cl. CPC C07F 5/069; B01J 31/0278; B01J 31/0298; B01J 31/4092; B01J 35/12; B01J 38/56; B01J 38/02; B01D 1/26; B01D 29/94; B01D 29/92; B01D 35/00; B01D 1/065; B01D 3/14

(57) ABSTRACT

The instant disclosure relates to liquid salts such as but not limiting to ionic liquids; and method for recovering liquid salts including ionic liquids. Ionic liquids get deactivated due to presence of various contaminants or impurities. The present disclosure deals with recovery and regeneration of ionic liquids using compounds containing at least one coordinating agent to form adduct with metal compounds. The instant disclosure also includes an assembly for carrying out the recovery and regeneration of the ionic liquids.

### TECHNICAL FIELD

The instant disclosure relates to organic chemistry and liquid salts in general and ionic compounds in particular, applicable in various chemical reactions. Further, it includes method for recovering liquid salt, more particularly to ionic liquid. Ionic liquids get deactivated due to presence of various contaminants or impurities. The present disclosure relates to recovering and regenerating liquid salt such as but not limited to ionic liquid, where the said ionic liquid is mixed with compound containing at least one coordinating agent to form adduct with metal compounds such as metal salts. The adduct with the metal salts is then broken ionic complex giving the ionic liquid back again. The instant disclosure also includes a system for carrying out the recovery and regeneration of the ionic liquid.

### BACKGROUND

Salts result from neutralization reaction of an acid and a base. They are composed of related number of cations (positively charged ions) and anions (negatively charged ions) so that the product is electrically neutral (without a net charge). These component ions can be inorganic or organic, and salts as a whole can be monatomic, or polyatomic. Salts may be in solid form or liquid form, and salts in liquid state are known as liquid salts such as ionic liquids.

Ionic liquids are thus liquids that are composed entirely of ions or a combination of cations and anions. The so-called “low temperature” ionic liquids are generally organic salts with melting points less than 100 degrees C., often even lower than room temperature. Ionic liquids are suitable, for example, for use as catalysts and solvents in alkylation and polymerization reactions as well as in dimerization, oligomerization acetylation, metatheses and copolymerization reactions.

One class of ionic liquids is fused salt compositions, which are molten at low temperature and are useful as catalysts, solvents and electrolytes. Such compositions are mixtures of components which are liquids at temperatures below the individual melting points of the components.

Ionic liquids are defined as liquids whose make-up entirely comprises ions as a combination of cations and anions. The most common ionic liquids are those prepared from organic-based cations and inorganic or organic anions. Ionic liquids of pyridinium and imidazolium are perhaps the most commonly used cations. The most catalytically interesting ionic liquids are those derived from ammonium halides and Lewis acids (such as AlCl₃, TiCl₄, SnCl₄, FeCl₃ and the like). The prior art ionic liquid catalysts are less effective when used in various reactions such as the alkylation reactions. Further, these known ionic liquid catalysts are expensive. Accordingly, there is need for cost-effective ionic liquid compounds which can effectively catalyze various reactions.

Further, the future of ionic liquids gets halted when the question of recovery and regeneration comes into focus. The deactivation of various ionic liquids such as halo metal based ionic liquids, amine based ionic liquids, etc. occurs mainly due to the presence of various contaminants or impurities such as hydrocarbons, polymers, tar, etc. The formation of complex with ionic liquids or entrapment of ionic liquids in the tar or the contaminating impurity present in the reaction mixture is responsible for deactivation of the ionic liquid catalyst. Hence, there is a need to recover and regenerate the ionic liquid.

The prior art methods give partial recovery of ionic liquids. The complete recycling of halo metal based ionic liquid still remains a challenging task. The industrial application of halo metal based ionic liquids gets diminished due to problems associated with their recovery and reusability. Further, the methods available in prior art result in loss of active sites in the regenerated catalyst and employ excess use of coordinating solvent. The present disclosure aims to overcome the drawbacks observed in the currently available technology for recovery and regeneration of ionic liquid.

### SUMMARY OF THE DISCLOSURE

Accordingly, the present disclosure relates to liquid salt including but not limiting to ionic liquid; and recovery and regeneration of liquid salt more particularly to ionic liquid.

In an embodiment, the present disclosure relates to method of recovery and regeneration of ionic liquid such as but not limiting to metal based ionic liquid.

In a preferred embodiment, the present disclosure relates to method of recovery and regeneration of ionic liquid such as but not limiting to halo metal based ionic liquid.

In an exemplary embodiment, the method of recovery and regeneration of ionic liquid is carried out using compound containing at least one coordinating agent.

In another exemplary embodiment, the recovery and regeneration of ionic liquid involves complete removal of contaminants or impurities from the ionic liquid.

The present disclosure relates to a method of recovery of ionic liquid, said method comprising acts of: contacting spent ionic liquid with compound containing at least one coordinating agent to obtain mixture comprising adduct, optionally post mixing the spent ionic liquid with solvent; separating the mixture of step a) to obtain filtered adduct; and heating the filtered adduct to obtain recovered ionic liquid.

The present disclosure also relates to a system for recovery and regeneration of ionic liquid.

In an embodiment, the system (100) for recovery of ionic liquid comprises: at least first reactor (102) adapted to receive spent ionic liquid and compound containing at least one coordinating agent to obtain mixture comprising adduct; at least one solid separation unit (103) fluidly connected to the at least one first reactor, wherein the at least one solid separation unit is configured to obtain the adduct and filtrate; at least one evaporator (105) fluidly connected to the at least one solid separation unit (103), wherein the at least one evaporator is adapted to receive the adduct from the at least one solid separation unit, and is configured to break the adduct into the compound containing at least one coordinating agent and the ionic liquid; and at least one second reactor (106), fluidly connected to the at least one evaporator (105), wherein the at least one second reactor is adapted to receive the ionic liquid from the at least one evaporator for recovery of ionic liquid.

The present disclosure also relates to a method for recovery of ionic liquid, said method comprising acts of: subjecting the spent ionic liquid to system (100), wherein the spent ionic liquid is added to first reactor (102); adding compound containing at least one coordinating agent to the first reactor (102) to obtain mixture comprising adduct; subjecting the mixture comprising adduct to solid separation unit (103) to obtain the adduct and filtrate, and subjecting the adduct to evaporator (105) for breaking the adduct into the compound containing at least one coordinating agent and the ionic liquid; followed by removal of the compound containing at least one coordinating agent; and subjecting the ionic liquid obtained from the evaporator to second reactor (106) and for recovery of the ionic liquid.

### BRIEF DESCRIPTION OF THE ACCOMPANYING FIGURE

In order that the disclosure may be readily understood and put into practical effect, reference will now be made to exemplary embodiments as illustrated with reference to the accompanying figure. The figure together with detailed description below, are incorporated in and form part of the specification, and serve to further illustrate the embodiments and explain various principles and advantages, in accordance with the present disclosure where:

FIG. 1 depicts an exemplary embodiment of the present disclosure which illustrates block diagram of the system for recovering and regenerating ionic liquid.

### DETAILED DESCRIPTION

The present disclosure relates to a method of recovery of ionic liquid, said method comprising acts of:
a) contacting spent ionic liquid with compound containing at least one coordinating agent to obtain mixture comprising adduct, optionally post mixing the spent ionic liquid with solvent;
b) separating the mixture of step a) to obtain filtered adduct; and
c) heating the filtered adduct to obtain recovered ionic liquid.

The present disclosure also relates to a system (100) for recovery of ionic liquid, said system comprising:
a) at least first reactor (102) adapted to receive spent ionic liquid and compound containing at least one coordinating agent to obtain mixture comprising adduct;
b) at least one solid separation unit (103) fluidly connected to the at least one first reactor, wherein the at least one solid separation unit is configured to obtain the adduct and filtrate;
c) at least one evaporator (105) fluidly connected to the at least one solid separation unit (103), wherein the at least one evaporator is adapted to receive the adduct from the at least one solid separation unit, and is configured to break the adduct into the compound containing at least one coordinating agent and the ionic liquid; and
d) at least one second reactor (106), fluidly connected to the at least one evaporator (105), wherein the at least one second reactor is adapted to receive the ionic liquid from the at least one evaporator for recovery of ionic liquid.

The present disclosure relates to a method for recovery of ionic liquid, said method comprising acts of:
a) subjecting the spent ionic liquid to system (100), wherein the spent ionic liquid is added to first reactor (102);
b) adding compound containing at least one coordinating agent to the first reactor (102) to obtain mixture comprising adduct;
c) subjecting the mixture comprising adduct to solid separation unit (103) to obtain the adduct and filtrate, and subjecting the adduct to evaporator (105) for breaking the adduct into the compound containing at least one coordinating agent and the ionic liquid; followed by removal of the compound containing at least one coordinating agent; and
d) subjecting the ionic liquid obtained from the evaporator to second reactor (106) and for recovery of the ionic liquid.

In an embodiment of the present disclosure, the adduct is formed between the ionic liquid and the compound containing at least one coordinating agent.

In another embodiment of the present disclosure, the recovery of the ionic liquid is carried out under inert atmosphere; and wherein the inert atmosphere is N2 atmosphere.

In yet another embodiment of the present disclosure, the ionic liquid is selected from group comprising phosphonium based ionic liquid, ammonium based ionic liquid and metal based ionic liquid or any combination thereof.

In still another embodiment of the present disclosure, amount of impurity present in the spent ionic liquid is ranging from about 10 w/w % to about 50 w/w %, preferably from about 20 w/w % to about 30 w/w %.

In still another embodiment of the present disclosure, the compound containing at least one coordinating agent is selected from group comprising secondary alcohol, aromatic alcohol, phenol and ketone or any combination thereof; wherein the secondary alcohol is selected from group comprising isopropanol or 2-butanol or combination thereof, preferably isopropanol, the aromatic alcohol is 1-phenylethanol and the ketone is acetone; wherein ratio of concentration of compound containing at least one coordinating agent to that of metal halide of the ionic liquid is ranging from about 1:1 to about 1:18 mole, preferably about 1:3 to about 1:6 mole ratio.

In still another embodiment of the present disclosure, the solvent is selected from group comprising hydrocarbon, ethyl acetate, acetonitrile and dichloromethane or any combination thereof; and wherein the hydrocarbon solvent is selected from group comprising benzene, pentane, hexane, heptane, octane, nonane and decane, or any combination thereof, preferably hexane.

In still another embodiment of the present disclosure, ratio of the amount of the solvent to that of the spent ionic liquid is ranging from about 0.5:1 to about 10:1, preferably from about 1:1 to about 4:1.

In still another embodiment of the present disclosure, the contacting of the spent ionic liquid with the compound containing at least one coordinating agent is at a temperature ranging from about −5° C. to about 50° C., preferably about 20° C. to about 30° C., for a time period ranging from about 0.5 hour to about 3 hours, preferably about 2.5 hours to about 3 hours.

In still another embodiment of the present disclosure, the separating is by techniques selected from group comprising filtration, centrifugation, pressure nutsche filtration, agitated nutsche filtration, vacuum belt filtration and vacuum filtration or any combination thereof.

In still another embodiment of the present disclosure, the adduct of step b) of the method of recovery is subjected to washing with solvent, and wherein the said solvent is selected from group comprising secondary alcohol, aromatic alcohol, phenol, ketone, hydrocarbon, ethyl acetate, acetonitrile and dichloromethane or any combination thereof; wherein amount of the said solvent is ranging from about 0 g to about 100 g, preferably from about 25 g to about 75 g.

In still another embodiment of the present disclosure, the filtered adduct obtained in step c) of the method of recover comprises the adduct formed between the ionic liquid and the coordinating agent; wherein the heating of the filtered adduct breaks the bond between the ionic liquid and the compound containing at least one coordination agent, and wherein the heating is carried out at temperature ranging from about 60° C. to about 160° C., preferably about 130° C. to about 140° C.

In still another embodiment of the present disclosure, compound selected from group comprising solvent and metal halide or combination thereof is added to the recovered ionic liquid of step c); concentration of the said solvent is ranging from about 5 w/w % to about 50 w/w %, preferably about 15 w/w % to about 30 w/w %; wherein the solvent is benzene; wherein concentration of the said metal halide is ranging from about 43 w/w % to about 65 w/w %; wherein the concentration indicated herein is w/w % of the total weight of the reaction medium. wherein the metal of the metal halide is selected from group comprising aluminium, iron, zinc, manganese, magnesium, titanium, tin, palladium, platinum, rhodium, copper, chromium, cobalt, cerium, nickel, gallium, indium, antimony and zirconium or any combination thereof; and the halogen of the metal halide is selected from group comprising fluorine, chlorine, bromine, iodine and astatine or any combination thereof.

In still another embodiment of the present disclosure, the system is operational in mode selected from group comprising batch mode, semi-continuous mode and continuous mode, or any combination thereof.

In still another embodiment of the present disclosure, the mixing unit (101) is selected from group comprising stirred vessel, static mixer, jet mixer and pump mixer, or any combination thereof.

In still another embodiment of the present disclosure, the first reactor (102) is selected from group comprising stirred tank reactor and static mixer or combination thereof.

In still another embodiment of the present disclosure, the solid separation unit (103) is selected from group comprising filter, centrifuge, pressure nutsche filter, agitated nutsche filter, vacuum filter and filter-dryer combination such as agitated nutsche filter dryer or any combination thereof.

In still another embodiment of the present disclosure, the evaporator (105) is selected from group comprising single effect evaporator, multiple effect evaporator, falling film evaporator, agitated thin film evaporator and evaporator-dryer combination or any combination thereof.

In still another embodiment of the present disclosure, the dryer is selected from group comprising tray-dryer and agitated thin film dryer or combination thereof.

In still another embodiment of the present disclosure, the distillation unit (104) is selected from group comprising single stage tray column, multi stage tray column, packed column and falling film evaporator or any combination thereof.

In still another embodiment of the present disclosure, the second reactor (106) is selected from group comprising stirred tank reactor and static mixer or combination thereof.

In still another embodiment of the present disclosure, the mixture comprising spent ionic liquid and compound containing at least one coordinating agent is at a temperature ranging from about −5° C. to about 50° C., preferably about 20° C. to about 30° C., for a time period ranging from about 0.5 hour to about 3 hours, preferably about 2.5 hours to about 3 hours; wherein the adduct is subjected to washing with solvent; wherein the said solvent for washing is selected from group comprising secondary alcohol, aromatic alcohol, phenol, ketone, hydrocarbon, ethyl acetate, acetonitrile and dichloromethane or any combination thereof; wherein amount of the said solvent is ranging from about 0 g to about 100 g, preferably from about 25 g to about 75 g; wherein the filtered adduct obtained in step c) comprises the adduct formed between the ionic liquid and the coordinating agent.

The system as claimed in claim 2, wherein the system comprises a mixing unit (101) fluidly connected to the at least one first reactor (102), wherein the mixing unit is configured to mix the spent ionic liquid with solvent before supplying to the at least one first reactor (102); wherein the system comprises at least one distillation unit (104) fluidly connected to the at least one solid separation unit, wherein the at least one distillation unit (104) is configured to distil out solvent and the compound containing at least one co-ordinating agent from the filtrate; wherein the filtrate comprises solvent, compound containing at least one coordinating agent or impurity or any combination thereof; and wherein the filtrate is present in a form selected from group comprising solid, liquid and gas or any combination thereof.

In still another embodiment of the present disclosure, the system comprises a fluid flow passage connected between compound containing at least one coordinating agent flow stream and at least one of the distillation unit (104) or the at least one evaporator (105) or combination thereof, for recycling the compound containing at least one coordinating agent to the at least one first reactor.

In still another embodiment of the present disclosure, the system comprises fluid bypass passage connected between compound containing at least one coordinating agent flow stream and the at least one solid separation unit (103) for supplying the compound containing at least one coordinating agent.

In still another embodiment of the present disclosure, the system comprises bypass passage connected between compound flow stream and the at least one second reactor (106) for recovering the ionic liquid, wherein the said compound is selected from group comprising solvent or metal halide or a combination thereof.

In still another embodiment of the present disclosure, the spent ionic liquid is mixed with solvent in mixing unit (101) prior to adding to the first reactor (102); wherein the filtrate obtained in step c) is subjected to distillation unit (104) to distil out the solvent or the compound containing at least one coordinating agent or combination thereof; and wherein the recovered ionic liquid of step d) is contacted with compound selected from group comprising solvent and metal halide or combination thereof; wherein the filtrate comprises solvent, compound containing at least one coordinating agent or impurity or any combination thereof; wherein the filtrate is present in a form selected from group comprising solid, liquid and gas or any combination thereof.

In an embodiment, the present disclosure relates to recovering ionic liquid, where the said ionic liquid is mixed with compound containing at least one coordinating agent to form adduct with metal compounds such as metal salts of the ionic liquid. The adduct between the compound containing at least one coordinating agent and the metal salt of the ionic liquid is broken for recycle of the ionic liquid.

The present disclosure relates to a method of recovering and regenerating salt preferably liquid salt including but not limiting to ionic liquid; by mixing the salt with at least one compound which allows adduct formation.

In an embodiment of the present disclosure, the terms ‘catalyst’, ‘ionic liquid’, ‘ionic liquid catalyst’ and ‘ionic catalyst’ are used interchangeably.

In an embodiment of the present disclosure, the terms ‘recovery’, ‘reusing’, ‘regeneration’ of ionic liquid are also used interchangeably.

In an embodiment of the present disclosure, the term halo metal ionic liquid refers to halogen metal ionic liquid.

In an embodiment of the present disclosure, the term ‘spent catalyst’ or ‘spent ionic liquid’ implies catalyst/ionic liquid retrieved post a chemical reaction employing the said catalyst/ionic liquid, such as but not limiting to alkylation reaction, and comprises one or more impurities.

In an embodiment of the present disclosure, the term ‘contacting’ spent ionic liquid with compound containing at least one coordinating agent includes mixing for obtaining the adduct. In a non-limiting embodiment of the present disclosure, the mixing is carried out in a mixing unit (101).

In an embodiment of the present disclosure, the terms ‘contaminant’ and ‘impurity are used interchangeably. In an embodiment of the present disclosure, the term impurity includes any undesired substance present along with the spent ionic liquid. In an embodiment, the impurity is present in a form selected from group comprising solid, liquid and gas or any combination thereof.

In a non-limiting embodiment of the present disclosure, the impurity is selected from a group comprising but not limiting to polymer, tar, unreacted compound containing coordination agent, moisture and hydrocarbon such as parrafin, benzene, olefins, etc., or any combination thereof.

In an embodiment, recovery and regeneration of ionic liquids is required owing to deactivation of ionic liquids; due to presence of various contaminants or impurities etc. such as but not limiting to tar, hydrocarbons, polymers, moisture etc. In certain embodiments, these ionic liquids such as metal based ionic liquids or halo metal based ionic liquids also get deactivated due to contaminants, impurities or various other components present at the reaction locations or in the reaction mass.

In another embodiment, the deactivation of ionic liquid is due to formation of complex with ionic liquids or entrapment of ionic liquids in the tar or the contaminating impurity present in the reaction mixture/mass. The contamination or presence of impurities results in the deactivation of active sites of the ionic liquid.

In an embodiment of the present disclosure, the impurity is analysed by gas chromatography.

In an embodiment of the present disclosure, amount of the impurity present in spent catalyst is ranging from about 10% to about 50% 20% to about 40%, preferably about 20% to about 30%. In an embodiment of the present disclosure, the ionic liquid in spent catalyst is ranging from about 50% to about 90%, preferably about 60% to about 80%, more preferably about 70% to about 80%. In an embodiment, the amount indicated herein is w/w % of the total weight of the spent ionic liquid.

The present disclosure also relates to complete removal of contaminants or impurities such as but not limiting to hydrocarbons, polymers, tar, moisture etc. from the ionic liquid.

In an embodiment the hydrocarbons are saturated or unsaturated hydrocarbons.

The present disclosure relates to method of recovery and regeneration of ionic liquid using at least one compound which allows adduct formation, including but not limited to compound containing at least one coordinating agent.

In an embodiment, the present disclosure relates to method of recovery and regeneration of metal based ionic liquid, preferably halo metal based ionic compound, more preferably halo metal-ammonium based ionic compound, using compound containing at least one coordinating agent.

In an exemplary embodiment, the metal based ionic liquid is mixed with compound containing at least one coordinating agent to form an adduct thereby separating other contaminants or impurities such as but not limiting to tar, hydrocarbons, polymers, moisture etc. Resulting adduct is broken to regain the metal compounds/derivatives, thus giving the ionic liquid back again.

In another non-limiting embodiment, the said halo metal based ionic liquid is mixed with compound containing at least one coordinating agent to form an adduct with ionic complex thereby separating other contaminants or impurities such as but not limiting to tar, hydrocarbons, polymers, moisture etc. Resulting adduct is broken to regain ionic complex, thus giving the pure ionic liquid back again. In a non-limiting embodiment the resulting adduct is thermally broken to obtain ionic complex.

In yet another non-limiting embodiment, the said halo metal-ammonium based ionic liquid is mixed with compound containing at least one coordinating agent to form an adduct with ionic complex thereby separating other contaminants or impurities such as but not limiting to tar, hydrocarbons, polymers, moisture etc. Resulting adduct is broken to regain ionic complex, thus giving the pure ionic liquid back again. In a non-limiting embodiment the resulting adduct is thermally broken to obtain ionic complex.

In another non-limiting embodiment, the resulting adduct is thermally broken to obtain ionic complex by subjecting it to temperature ranging from about 60° C. to about 160° C.

In an exemplary embodiment, the compound containing at least one coordinating agent is a solvent. In another embodiment the compound containing at least one coordinating agent is selected from but not limited to compound containing ‘O’ as coordinating agent.

In an exemplary embodiment, the compound containing at least one coordinating agent is selected from organic or inorganic compound. In another non-limiting embodiment, the organic compound containing at least one coordinating agent is selected from but not limited to alcohol such as secondary alcohol or aromatic alcohol, preferably isopropanol; or phenols or ketones or any combinations thereof. In an exemplary embodiment, the secondary alcohol is selected from group comprising isopropanol or 2-butanol or combination thereof, the aromatic alcohol is 1-phenylethanol and the ketone is acetone,

In a preferred embodiment, compound containing at least one coordinating agent is isopropanol (IPA).

In an embodiment, mixing of used ionic liquid, with compound containing at least one coordinating agent allows formation of adduct between the coordinating agent of the compound and ionic liquid leaving behind all the impurities like tar, hydrocarbons, polymers, etc.

In a non-limiting embodiment, the adduct forming agent is selected from organic or inorganic compound containing Oxygen or Nitrogen or Sulphur or Phosphorus or any combinations thereof. In another exemplary embodiment, the adduct forming agent is a solvent selected from organic and inorganic solvents.

In an embodiment of the present disclosure, addition of the solvent aids in decreasing viscosity of slurry/mixture obtained on addition of compound containing at least one coordinating agent to ionic liquid

In yet another embodiment, the organic solvents are selected from but not limiting to hydrocarbon or ethyl acetate or acetonitrile or dichloromethane or any combinations thereof. The hydrocarbon adduct forming agent is further selected from saturated and unsaturated hydrocarbon such as but not limiting to benzene, pentane, hexane, heptane, octane, nonane, decane, etc.

In a preferred embodiment of the present disclosure, the solvent is saturated hydrocarbon.

In a preferred embodiment of the present disclosure, the solvent is hexane. Hexane is hydrophobic solvent and removes unsaturated hydrocarbon, tar, and other impurities from spent catalyst. Hence deactivation of active sites in the catalyst can be avoided which results in better yield of mixture of adduct as well as regenerated catalyst. In an embodiment, use of hexane results in less than about 25% of solid loading in the system and reduces the viscosity of slurry/mixture obtained on addition of compound containing at least one coordinating agent to ionic liquid. Further, hexane is insoluble in solids, and has low boiling point, and hence it is easily separated.

In an embodiment, the present disclosure provides for stoichiometric use of coordinating solvent. Stoichiometric use of the coordinating solvent avoids problem associated with separation of coordinating solvent.

In another exemplary embodiment, the compound containing at least one coordinating agent is itself used as the adduct forming agent solvent. In this scenario, excess amount of the compound containing at least one coordinating agent is used.

In an embodiment, after addition of compound containing at least one coordinating agent, the resultant solid-liquid mixture is filtered and the wet solid is washed with the compound containing at least one coordinating agent or with different solvent to remove any adsorbed contaminant or impurity on the surface. The resulting solid is a complex adduct formed between the ionic liquid and the compound containing at least one coordinating agent, wherein the compound containing at least one coordinating agent is solvent. The solvent used to remove adsorbed contaminant or impurity is selected from but not limited to organic and inorganic solvents.

In an embodiment, the mole ratio of the compound containing at least one coordinating agent to the ionic liquid present in the spent catalyst varies from about 1:1 to about 1:18. Temperature controls the adduct formation and it is shuffled from about −5° C. to about 50° C. to get maximum yield of adduct.

In an embodiment of the present disclosure, ratio of concentration of compound comprising at least one coordinating agent with respect to the ionic liquid is ranging from about 1:1 to about 1:18 mole, preferably about 1:3 to about 1:6 mole ratio.

In another embodiment of the present disclosure, ratio of concentration of compound comprising at least one coordinating agent with respect to the spent ionic liquid is ranging from about 1:1 to about 1:18 mole, preferably about 1:3 to about 1:6 mole ratio.

In an embodiment of the present disclosure, ratio of concentration of compound comprising at least one coordinating agent with respect to metal halide of the ionic liquid is ranging from about 1:1 to about 1:18 mole, preferably about 1:3 to about 1:6 mole ratio.

In another embodiment of the present disclosure, ratio of concentration of compound comprising at least one coordinating agent with respect to metal halide of the spent ionic liquid is ranging from about 1:1 to about 1:18 mole, preferably about 1:3 to about 1:6 mole ratio.

In an embodiment, yield of the ionic liquid recycled as per the method of the present is disclosure is ranging from about at least 50% to about 100%. In an embodiment, the yield of the ionic liquid recycled as per the method of the present is disclosure is at least about 50%, at least about 60%, at least about 70%, at least about 80%, at least about 90%, at least about 95%, or at least about 99%.

In an embodiment, the ionic liquid is selected from but not limited to compounds based on phosphonium or ammonium or metal or any combination thereof. In another embodiment, the ionic liquid including but not limiting to halo metal based ionic liquid with the compound containing at least one coordinating agent is in the presence of an adduct forming agent including but not limited to a solvent.

In a non-limiting embodiment, the instant disclosure relates to ionic liquids and method of recovering and regenerating ionic liquids such as but not limited to metal based ionic liquids.

In a preferred embodiment, the present disclosure relates to method of recovering and regenerating ionic liquid such as but not limited to halo metal based ionic liquid.

In an exemplary embodiment, the metal of the ionic liquid is selected from but not limited to Aluminium (Al), Iron (Fe), Zinc (Zn), Manganese (Mn), Magnesium (Mg), Titanium (Ti), Tin (Sn), Palladium (Pd), Platinum (Pt), Rhodium (Rh), Copper (Cu), Chromium (Cr), Cobalt (Co), Cerium (Ce), Nickel (Ni), Gallium (Ga), Indium (In), Antimony (Sb) and Zirconium (Zr) or any combinations thereof; and the halogen of the halo metal based ionic liquid is selected from Fluorine (F), Chlorine (Cl), Bromine (Br), Iodine (I) and Astatine (At).

In a preferred non-limiting embodiment, the metal based ionic liquid is metal salt ionic liquid.

In a preferred embodiment, the present disclosure relates to method of recovering and regenerating ionic liquid such as but not limited to amine based ionic liquid.

In an exemplary embodiment, the amine group of the ionic liquid is selected from but not limited to trimethylamine, triethylamine, triphenylamine, n,n-dimethylaniline, methylamine, dimethylamine, aziridine, piperidine, methyl ethanolamine and nitroanilines or any combination thereof.

In an embodiment, the present disclosure relates to method of recovering and regenerating ionic liquid such as but not limited to halo metal-amine based ionic liquid.

The present disclosure in an embodiment conveys the chemistry and process for the recovery and regeneration of ionic liquids such as but not limiting to chloroaluminate ionic liquids. In a non-limiting embodiment the ionic liquid finds applications in various chemical reactions of industrial relevance.

In a non-limiting embodiment, the said ionic liquid/ionic liquid catalyst used for recovery is having a general formula of:

[(NR₁R₂R₃)ᵢM₁]ⁿ⁺[(M₂Yₖ)_{L}Sⱼ]ⁿ⁻ Formula I
wherein,
NR₁R₂R₃ represents an amine,
R₁, R₂ and R₃ are independently selected from but not limited to alkyl, aryl and H, or any combinations thereof,
M₁ or M₂ is a metal selected from but not limited to Al, Fe, Zn, Mn, Mg, Ti, Sn, Pd, Pt, Rh, Cu, Cr, Co, Ce, Ni, Ga, In, Sb and Zr or any combinations thereof,
X or Y is selected from but not limited to halogen, nitrate, sulphate, sulfonate, carbonate, phosphonate and acetate or any combinations thereof,
   ‘n’ represents 1 to 4,
   ‘i’ represents 1 to 6,
   ‘j’ represents 1 to 4,
   ‘k’ represents 1 to 4,
   ‘L’ represents 1 to 7,
   M₁=M₂ or M₁≠M₂, and
   X=Y or X≠Y.

In a non-limiting embodiment, an electron acceptor such as metal halide forms adduct with an electron donor such as amine/ammonium based group, in a ratio of about 1:1 to about 1:5, in presence or absence of a solvent, to form an adduct between the electron acceptor-electron donor. Further, the adduct is reacted in presence or absence of a solvent with the same or different electron acceptor in a ratio of about 1:2 to about 1:6 to give ionic liquid catalyst. This catalyst gets deactivated in any chemical reaction. Losing catalyst increases the economy of process and disposal of deactivated ionic salts becomes a monotonous work. In an embodiment of the present disclosure, chemical reaction is selected from group comprising catalysis, alkylation reaction, trans-alkylation reaction, acylation reaction, polymerization reaction, dimerization reaction, oligomerization reaction, acetylation reaction, metatheses reaction, pericyclic reaction and copolymerization reaction or any combination thereof.

In a non-limiting embodiment, aluminium chloride forms adduct with 3 moles of triethylamine to give [(Et₃N)₃—Al]³⁺[(Cl)₃]³⁻ and further addition of another 6 moles of aluminium chloride gives ionic liquid catalyst [(Et₃N)₃—Al]³⁺[(AlCl₃)₆Cl₃]³⁻. This catalyst gets deactivated in any chemical reaction such as alkylation reaction. Losing catalyst increases the economy of process and disposal of deactivated ionic salts becomes a monotonous work.

In such situations the instant process gives an insight in recovery and regeneration of ionic liquid catalyst such as halo metal based ionic liquid, by addition of compound containing at least one coordinating agent which is able to selectively separate ionic liquid from reaction mass of alkylation process. When compound containing at least one coordinating agent such as isopropanol is added to the above ionic liquid spent catalyst, a complex adduct is formed between the ionic liquid and isopropanol, which thermally breaks at higher temperatures leaving behind the ionic liquid back again. There may be a marginal loss of the metal halide such as AlCl₃, as a result, addition of merely about 0.1-3 moles of fresh aluminium chloride gives regenerated ionic liquid catalyst, thus tumbling the economics for preparation and regeneration of ionic liquid catalyst.

In an embodiment, the method of the present disclosure does not result in complete loss of anions of the ionic liquid which is being recycled. In another embodiment, the method of the present disclosure results in complete removal of impurity or contaminant from ionic liquid.

In an embodiment of the present disclosure, addition of metal halide make-up compound is at a concentration ranging from about 0.1 moles to about 3.5 moles.

The present disclosure also relates to a system (100) for recovery and regeneration of ionic liquid, wherein the system is operational in either batch or semi-continuous or continuous mode.

In a non-limiting embodiment, the ionic liquid to be recovered and regenerated is subjected sequentially to a mixing unit, reactor, filtering unit, evaporator, distillation unit and a second reactor.

In an embodiment, the whole assembly for recovery and regeneration of ionic liquid is kept under N₂ atmosphere.

In another embodiment, the ionic liquid to be recovered and regenerated is either directly sent to the reactor or mixed with solvent in the mixing unit and then sent to reactor. The solvent used is organic or inorganic solvent, selected from group comprising but not limited to benzene, pentane, heptane, hexane, octane, nonane, decane, ethyl acetate, acetonitrile and dichloromethane or any combination thereof. In an embodiment of the present disclosure, the ratio of the amount of the said solvent employed to that of the spent ionic liquid is ranging from about 0.5:1 to about 10:1, preferably from about 1:1 to about 4:1. Compound containing at least one coordinating agent is added to the first reactor either by batch mode or continuous mode; and the reaction is allowed to progress to complete adduct formation. The slurry mass or resultant mixture comprising adduct, obtained from first reactor, is sent to the solid separation unit such as but not limiting to filter unit, and the solids are washed to remove the traces of contaminants or impurities [if any]. In an embodiment, the solids separated from the solid separation unit are washed with organic or inorganic solvents, such as but not limiting to isopropanol, ethyl acetate etc. In another embodiment, the solvent used for washing is the compound containing at least one coordinating agent. In an embodiment of the present disclosure, the concentration of the solvent used for washing is ranging from about 0 g to about 100 g, preferably from about 25 g to about 75 g. The solids/adduct retained in the solid separation unit are sent to evaporator where breaking of metal compounds such as but not limiting to metal halide and coordinating agent (of the compound containing at least one coordinating agent) adduct takes place to result in filtrate and solid/liquid. In an embodiment, the breaking of bond between the metal compound such as metal halide and the coordinating agent (of the compound containing at least one coordinating agent) in the adduct is carried out thermally. The filtrate obtained from the solid separation unit is sent to the distillation unit to distill out solvent or compound containing at least one coordinating agent including as a solvent or mixture thereof; which is recycled, leaving behind any contaminants or impurities as residue. The solid/liquid ionic liquid obtained from evaporator is transferred to the second reactor where the ionic liquid is diluted with suitable solvent such as organic or inorganic solvents, selected from but not limited to benzene. Further, in an embodiment, additional or make-up compounds such as metal halide of about 0.1-3 mole, solvents ranging from about 5 w/w % to about 50 w/w %, preferably about 15 w/w % to about 30 w/w % is added for complete ionic liquid formation in case of metal halide loss if any. In an embodiment, the amount indicated herein is w/w % of the total weight of the reaction medium.

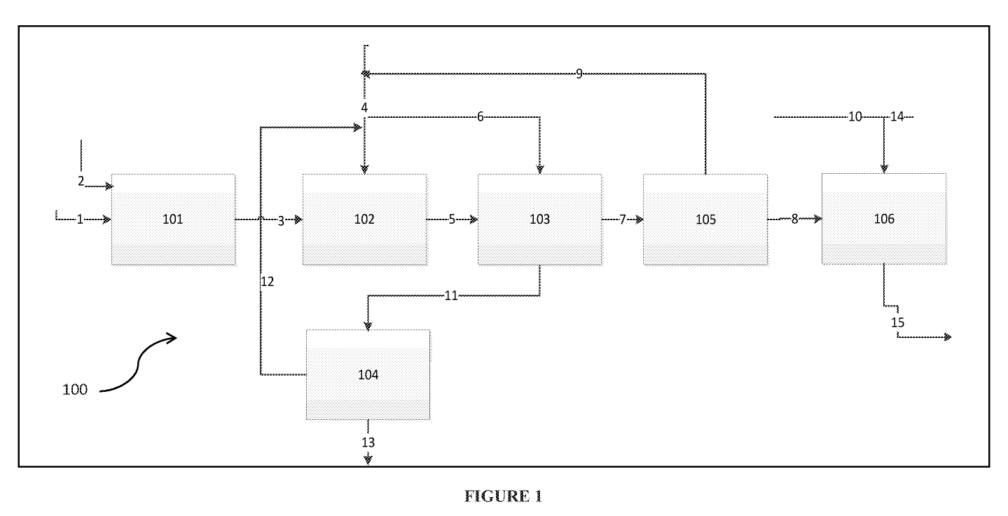

FIG. 1 is an exemplary embodiment of the present disclosure which illustrates block diagram of the system for recovering and regenerating ionic liquid. The system is operated in either batch or semi-continuous or continuous mode for recovering and regenerating the ionic liquid. The system comprises mixing unit (101) for receiving and mixing ionic liquid such as metal ionic liquid including halo metal ionic liquid, to be recovered and regenerated through stream 1 and solvent from stream 2. In an embodiment, the mixing unit (101) is pre-mixer, and the pre-mixer is at least one of but not limiting to stirred vessel, static mixer, jet mixer and pump mixer or any combinations thereof. The system comprises a first reactor (102) fluidly connected to the mixing unit (101) via stream 3 for receiving the mixture of ionic liquid and the solvent. The first reactor (102) includes but is not limiting to a stirred tank reactor and a static mixer or combination thereof. Addition of compound containing at least one coordinating agent is done via stream 4 to the first reactor (102). From the first reactor (102), slurry/mixture comprising adduct is sent to a solid separation unit (103) such as but not limited to filter, centrifuge, pressure nutsche filter, agitated nutsche filter, vacuum belt filter and vacuum filter or any combination thereof; or a filter-dryer combination such as agitated nutsche filter dryer. In an embodiment the compound containing at least one coordinating agent is solvent. The solid separation unit (103) is fluidly connected to the first reactor (102) via stream 5. The system also comprises an evaporator (105), which includes but is not limited to single effect evaporator or multiple effect evaporator or falling film evaporator or agitated thin film evaporator or combinations thereof; the evaporator can also be a combination of evaporator and dryer, where the said dryer is tray-dryer, agitated thin film dryer or combinations thereof. The evaporator is also connected to the stream 9, which has the compound containing at least one coordinating agent, optionally in the form of a solvent flowing through it. Further, a distillation unit (104) which includes but is not limited to single or multi stage tray column or packed column or falling film evaporator or combinations thereof is provided in the system, and is fluidly connected via stream 11 to downstream of the solid separation unit (103) for removing the solvent, compound containing at least one coordinating agent or mixture thereof, leaving behind contaminant or impurities residues. The system also comprises a second reactor (106) fluidly connected via stream 8 to the evaporator (105) for optional addition of make-up compounds such as metal halide and/or/solvents. The second reactor (106) includes but is not limited to a stirred tank reactor or a static mixer or combination thereof. The regenerated catalyst is collected through stream 15 from the second reactor.

The halo metal based ionic liquid to be recovered and regenerated, the compound containing at least one coordinating agent, the various solvents employed etc are all introduced into the various units by way of the streams, flow channels, etc as depicted in FIG. 1.

In an embodiment, the Stream 1 containing halo metal ionic liquid to be recovered and regenerated is either directly sent to reactor (102) or it is mixed with suitable solvent in stream 2 in the mixing unit (101) and then sent to first reactor (102) via stream 3. Addition of compound containing at least one coordinating agent to the reactor is done via stream 4. The mode of addition is either in batch mode or in continuous mode. The residence time or the reaction time in the first reactor (102) varies from about 0.5 hr to about 3 hours in order to have complete adduct formation. The slurry mass from first reactor (102) is sent into solid separation unit (103) via stream 5. The solids are washed with excess solvent supplied to the solid separation unit (103) via stream 6 to remove the traces of contaminants or impurities such as but not limited to tar, unsaturated hydrocarbons, polymers, moisture etc. if any.

The solids retained in the solid separation unit (103) are sent to evaporator (105) through stream 7 where the solids are heated; and where breaking of the adduct formed between the metal halide and the compound containing at least one coordinating agent takes place above 120° C. This evaporation is done at atmospheric or under vacuum or combination of both. The filtrate obtained from the solid separation unit (103) is sent through stream 11 to distillation column of distillation unit (104) to distill out solvent or compound containing at least one coordinating agent or mixture thereof which are recycled via stream 12, leaving behind contaminants or impurities including but not limited to tar, polymers hydrocarbons, moisture as residue (stream 13). The solid/liquid obtained from evaporator (105) is transferred to the second reactor (106) where the ionic liquid is diluted with suitable solvent such as benzene via stream 14. Additional or make-up metal halide at about 0.1-3 mole is added via stream 10 for complete ionic liquid formation in case of metal halide loss if any. The regenerated catalyst is collected through stream 15 from the second reactor (106).

In an embodiment of the present disclosure, the solid sent to the evaporator is an amine complex bonded with adduct between metal halide of the ionic liquid and compound containing at least one coordinating agent. In evaporator, the bond between the compound containing at least one coordinating agent and metal halide of the ionic liquid breaks, leaving behind amine complex and metal halide which is called as precatalyst, while the compound containing at least one coordinating agent gets evaporated.

In an embodiment of the present disclosure, the stream 9 is also referred to as fluid flow passage connected between compound containing at least one coordinating agent flow stream and at least one evaporator (105).

In another embodiment of the present disclosure, the stream 12 is also referred to as fluid flow passage connected between compound containing at least one coordinating agent flow stream and at least one of the distillation unit (104).

In yet another embodiment of the present disclosure, the stream 6 is also referred to as fluid bypass passage connected between compound containing at least one coordinating agent flow stream and the at least one solid separation unit (103).

In still another embodiment of the present disclosure, the stream 10 or stream 14 is also referred to bypass passage connected between compound flow stream and the at least one second reactor (106) for recovering the ionic liquid.

In an embodiment of the present disclosure, room temperature (RT) is ranging from about 20° C. to about 35° C., preferably about 28° C.

In an embodiment, the present disclosure provides for an efficient and cost effective method for recycling and regenerating ionic liquid and a system thereof. In another embodiment, the method of the present disclosure improves flow of coordinating solvent-spent catalyst adduct obtained, employs lesser amount of solvent, increases yield of the recycled ionic liquid, provides for reuse of the solvent and the compound containing at least one coordinating agent. Additional embodiments and features of the present disclosure will be apparent to one of ordinary skill in art based upon description provided herein. The embodiments herein provide various features and advantageous details thereof in the description. Descriptions of well-known/conventional methods and techniques are omitted so as to not unnecessarily obscure the embodiments herein. Further, the disclosure herein provides for examples illustrating the above described embodiments, and in order to illustrate the embodiments of the present disclosure certain aspects have been employed. The examples used herein for such illustration are intended merely to facilitate an understanding of ways in which the embodiments herein may be practiced and to further enable those of skill in the art to practice the embodiments herein. Accordingly, the following examples should not be construed as limiting the scope of the embodiments herein.

### EXAMPLES

### Example 1

### Alkylation Reaction to Get Deactivated Catalyst

About 52.02 litres of hydrocarbon stream containing about 10-13% of C10-C14 olefins, about 87-90% paraffins and about 20.02 litres of benzene is charged into a 250 L glass reactor kept under an overhead stirrer, placed in a heating mantle. N₂ flow is ensured inside the reactor. The reactor is then heated to about 38-39° C. Once the temperature is achieved, about 0.7 kg of freshly prepared [Et₃N)₃—Al]³⁺[(AlCl₃)₆Cl₃]³⁻ ionic liquid catalyst is added to the reactor and stirred for a time duration of about 5 minutes. After about 5 minutes the reaction mass is allowed to settle for about 10 minutes. The layers are then separated. The upper hydrocarbon layer is then analysed. The conversion of benzene to linear alkyl benzene is found to be about 99.7%. The bottom spent/deactivated catalyst layer is kept aside.

### Example 2

### Recovery and Regeneration of Ionic Liquid Catalyst Using Isopropanol

About 300 g of spent catalyst obtained from EXAMPLE-1 (comprising about 25% impurity) is washed with benzene and is taken into a 2000 ml RB flask kept under an overhead stirrer. The whole assembly is kept under N₂ atmosphere. Thereafter, about 480 g of isopropanol, the compound containing at least one coordinating agent, is added dropwise to it for about 1 h. After addition, the whole mass is stirred for about another 3 hours for complete adduct formation. The resultant mixture is then separated by vacuum filtration where solid obtained is washed with isopropanol. About 273.68 g of used ionic liquid catalyst and isopropanol adduct is obtained with about 466.67 g of filtrate containing unreacted impurities such as isopropanol, tar, unsaturated hydrocarbon and polymers. The obtained solid is sent to evaporator at about 130-145° C. under cold water circulation and about 136.84 g of precatalyst and about 125.89 g of isopropanol is obtained. The filtrate is sent to distillation unit to separate isopropanol and tar, unsaturated hydrocarbon and polymers. About 24.77 g of the ionic complex containing metal chloride and adduct of metal chloride and amine is treated with about 7.431 g of benzene followed by addition of about 15.67 g of fresh aluminium chloride to get regenerated catalyst. To confirm the viability of the regenerated catalyst, alkylation of benzene is conducted in accordance to EXAMPLE 1 and results are in consonance with that of fresh catalyst.

### Example 3

### Recovery and Regeneration of Ionic Liquid Catalyst Using Isopropanol in Ethyl Acetate

About 50 g of spent ionic liquid catalyst obtained from EXAMPLE-1 (comprising about 25% impurity) is taken into a 250 ml RB flask kept under an overhead stirrer and about 50 g of ethyl acetate is added to this. The whole assembly is kept under N₂ atmosphere. Thereafter about 65.63 g of isopropanol, the compound containing at least one coordinating agent, is added dropwise to above solution for about 1 h. After addition the whole mass is stirred for another 3 hours for complete adduct formation. The resultant mixture is then separated by vacuum filtration where solid obtained is washed with additional about 50 g of ethyl acetate. About 47.86 g of spent/used ionic liquid catalyst and isopropanol adduct is obtained with about 73.54 g of filtrate containing impurities such as unreacted isopropanol, tar, unsaturated hydrocarbon and polymers. The obtained solid is sent to evaporator at about 130-145° C. under cold water circulation and about 24.42 g of precatalyst and about 23.86 g of isopropanol is obtained. The filtrate is sent to distillation unit to separate isopropanol and tar, unsaturated hydrocarbon and polymers. About 24.42 g of the ionic liquid complex containing metal chloride and adduct of metal chloride and amine is treated with about 7.326 g of benzene followed by addition about 15.33 g of fresh aluminium chloride to get regenerated catalyst. To confirm the viability of the regenerated catalyst, alkylation of benzene is conducted in accordance to EXAMPLE 1 and results are in consonance with that of fresh catalyst.

### Example 4

### Recovery and Regeneration of Ionic Liquid Catalyst Using Isopropanol and Hexane

About 150 g of spent catalyst obtained from EXAMPLE-1 (comprising about 25% impurity) is mixed with about 551 g of hexane to obtain a solution, and about −98.38 g of IPA is added dropwise to the above solution for about 1 h. Speed of agitation is maintained at about 450-500 rpm till the addition of the IPA, and after completion of the addition, it is maintained at about 500 rpm for about 3 h. The whole assembly is kept under N₂ atmosphere. The resultant mixture is then separated by vacuum filtration. The obtained solid cake is washed with about 50 g of hexane, for removing any remaining impurity in the adduct, and dried at room temperature. About 200 g of used ionic liquid catalyst and isopropanol adduct is obtained with about 588.5 g of filtrate containing unreacted isopropanol, tar, unsaturated hydrocarbon and polymers. The resulting solid is sent to evaporator and subjected to temperature ranging from about 130-140° C. under cold water circulation to remove IPA from AlCl₃: spent catalyst adduct, and about 109.125 g of precatalyst and about 90.3875 g of isopropanol is obtained. The filtrate is sent to distillation unit to separate isopropanol and tar, unsaturated hydrocarbon and polymers. About 109.125 g of the ionic complex containing metal chloride and adduct of metal chloride and amine is treated with about 3.375 g of metal halide, for preparing final catalyst. The parameters of the catalyst obtained are provided in Table 1 below. To confirm the viability of regenerated catalyst, alkylation of benzene is conducted in accordance to EXAMPLE 1 and results are in consonance with that of fresh catalyst. A comparative analysis of use of IPA and IPA-hexane for recovery and regeneration of ionic liquid.

TABLE 1

| Sl. No. | Parameters | IPA-hexane method |
|---|---|---|
| 1 | Yield | >95% |
| 2 | Requirement of coordinating agent | Only stoichiometry(1:3) |
| 3 | Adduct texture | Free flowing powder |
| 4 | Required metal halides to regenerate | 0.5-1.5 moles |
| | IL | |

Thus, the present disclosure is able to successfully overcome the various deficiencies of prior art and provide for an improved method for recovery and regeneration of ionic liquids.

Additional embodiments and features of the present disclosure will be apparent to one of ordinary skill in art based on the description provided herein. The embodiments herein provide various features and advantageous details thereof in the description. Descriptions of well-known/conventional methods and techniques are omitted so as to not unnecessarily obscure the embodiments herein.

The foregoing description of the specific embodiments fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments in this disclosure have been described in terms of preferred embodiments, those skilled in the art will recognize that the embodiments herein can be practiced with modification within the spirit and scope of the embodiments as described herein.

Throughout this specification, the word “comprise”, or variations such as “comprises” or “comprising” wherever used, will be understood to imply the inclusion of a stated element, integer or step, or group of elements, integers or steps, but not the exclusion of any other element, integer or step, or group of elements, integers or steps.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

REFERENCE NUMERAL TABLE

| Sl. No. | Reference No. | Description |
|---|---|---|
| 1 | 100 | System. |
| 2 | 101 | Mixing Unit. |
| 3 | 102 | First Reactor. |
| 4 | 103 | Solid Separation Unit. |
| 5 | 104 | Distillation Unit. |
| 6 | 105 | Evaporator. |
| 7 | 106 | Second Reactor. |
| 8 | Stream 1 | Connected to the Mixing Unit, for receiving |
| | | and mixing ionic liquid. |
| 9 | Stream 2 | Connected to the Mixing Unit, for receiving |
| | | Solvent. |
| 10 | Stream 3 | Connects the Mixing Unit with the First |
| | | Reactor. |
| 11 | Stream 4 | Connected to the First Reactor for addition |
| | | of compound containing atleast one |
| | | coordinating agent. |
| 12 | Stream 5 | Connects the First Reactor with the Solid |
| | | Separation Unit. |
| 13 | Stream 6 | Connected to Solid Separation Unit for |
| | | adding excess solvent/compound containing |
| | | atleast one coordinating agent. |
| 14 | Stream 7 | Connects the Solid Separation Unit with |
| | | the Evaporator |
| 15 | Stream 8 | Connects the Evaporator with the Second |
| | | Reactor. |
| 16 | Stream 9 | Connected to the Evaporator, wherein the |
| | | compound containing atleast one |
| | | coordinating agent flows through it. |
| 17 | Stream 10 | Connected to the Second Reactor for |
| | | adding additional or make-up compounds/ |
| | | solvents such as metal halide. |
| 18 | Stream 11 | Connects the Solid Separation Unit with |
| | | the Distillation Unit. |
| 19 | Stream 12 | Connected to Distillation Unit and distills |
| | | out recycled solvent. |
| 20 | Stream 13 | Connected to Distillation Unit and removes |
| | | contaminants or impurities residue. |
| 21 | Stream 14 | Connected to the Second Reactor for adding |
| | | solvent. |
| 22 | Stream 15 | Connected to the Second Reactor for |
| | | collecting the regenerated catalyst. |

1. A method of recovery of ionic liquid, said method comprising acts of:
a) contacting spent ionic liquid with compound containing at least one coordinating agent to obtain mixture comprising adduct, optionally post mixing the spent ionic liquid with solvent;
b) separating the mixture of step a) to obtain filtered adduct; and
c) heating the filtered adduct to obtain recovered ionic liquid.

2. A system (100) for recovery of ionic liquid, said system comprising:
a) at least first reactor (102) adapted to receive spent ionic liquid and compound containing at least one coordinating agent to obtain mixture comprising adduct;
b) at least one solid separation unit (103) fluidly connected to the at least one first reactor, wherein the at least one solid separation unit is configured to obtain the adduct and filtrate;
c) at least one evaporator (105) fluidly connected to the at least one solid separation unit (103), wherein the at least one evaporator is adapted to receive the adduct from the at least one solid separation unit, and is configured to break -the adduct into the compound containing at least one coordinating agent and the ionic liquid; and
d) at least one second reactor (106), fluidly connected to the at least one evaporator (105), wherein the at least one second reactor is adapted to receive the ionic liquid from the at least one evaporator for recovery of ionic liquid.

3. A method for recovery of ionic liquid, said method comprising acts of:
a) subjecting the spent ionic liquid to system (100), wherein the spent ionic liquid is added to first reactor (102);
b) adding compound containing at least one coordinating agent to the first reactor (102) to obtain mixture comprising adduct;
c) subjecting the mixture comprising adduct to solid separation unit (103) to obtain the adduct and filtrate, and subjecting the adduct to evaporator (105) for breaking the adduct into the compound containing at least one coordinating agent and the ionic liquid; followed by removal of the compound containing at least one coordinating agent; and
d) subjecting the ionic liquid obtained from the evaporator to second reactor (106) and for recovery of the ionic liquid.

4. The method as claimed in claim 1, wherein the adduct is formed between the ionic liquid and the compound containing at least one coordinating agent; wherein the recovery of the ionic liquid is carried out under inert atmosphere; wherein the inert atmosphere is N₂ atmosphere; wherein the ionic liquid is selected from group comprising phosphonium based ionic liquid, ammonium based ionic liquid and metal based ionic liquid or any combination thereof; and wherein amount of impurity present in the spent ionic liquid is ranging from about 10 w/w % to about 50 w/w %, preferably from about 20 w/w % to about 30 w/w %.

5. The method as claimed in claim 3, wherein the adduct is formed between the ionic liquid and the compound containing at least one coordinating agent; wherein the recovery of the ionic liquid is carried out under inert atmosphere; wherein the inert atmosphere is N₂ atmosphere; wherein the ionic liquid is selected from group comprising phosphonium based ionic liquid, ammonium based ionic liquid and metal based ionic liquid or any combination thereof; and wherein amount of impurity present in the spent ionic liquid is ranging from about 10 w/w % to about 50 w/w %, preferably from about 20 w/w % to about 30 w/w %.

6. The method as claimed in claim 1, wherein the compound containing at least one coordinating agent is selected from group comprising secondary alcohol, aromatic alcohol, phenol and ketone or any combination thereof; wherein the secondary alcohol is selected from group comprising isopropanol or 2-butanol or combination thereof, preferably isopropanol, the aromatic alcohol is 1-phenylethanol and the ketone is acetone; and wherein ratio of the concentration of compound containing at least one coordinating agent to that of metal halide of the ionic liquid is ranging from about 1:1 to about 1:18 mole, preferably about 1:3 to about 1:6 mole ratio.

7. The methods as claimed in claim 1, wherein the solvent is selected from group comprising hydrocarbon, ethyl acetate, acetonitrile and dichloromethane or any combination thereof; wherein the hydrocarbon solvent is selected from group comprising benzene, pentane, hexane, heptane, octane, nonane and decane, or any combination thereof, preferably hexane; and wherein ratio of the amount of the solvent to that of the spent ionic liquid is ranging from about 0.5:1 to about 10:1, preferably from about 1:1 to about 4:1.

8. The method as claimed in claim 1, wherein the contacting of the spent ionic liquid with the compound containing at least one coordinating agent is at a temperature ranging from about −5° C. to about 50° C., preferably about 20° C. to about 30° C., for a time period ranging from about 0.5 hour to about 3 hours, preferably about 2.5 hours to about 3 hours; and wherein the separating is by techniques selected from group comprising filtration, centrifugation, pressure nutsche filtration, agitated nutsche filtration, vacuum belt filtration and vacuum filtration or any combination thereof.

9. The method as claimed in claim 1, wherein the adduct of step b) is subjected to washing with solvent, and wherein the said solvent is selected from group comprising secondary alcohol, aromatic alcohol, phenol, ketone, hydrocarbon, ethyl acetate, acetonitrile and dichloromethane or any combination thereof; wherein amount of the said solvent is ranging from about 0 g to about 100 g, preferably from about 25 g to about 75 g; wherein the filtered adduct obtained in step c) comprises the adduct formed between the ionic liquid and the coordinating agent; wherein the heating of the filtered adduct breaks the bond between the ionic liquid and the compound containing at least one coordination agent, and wherein the heating is carried out at temperature ranging from about 60° C. to about 160° C., preferably about 130° C. to about 140° C.

10. The method as claimed in claim 1, wherein compound selected from group comprising solvent and metal halide or combination thereof is added to the recovered ionic liquid of step c); wherein concentration of the said solvent is ranging from about 5 w/w % to about 50 w/w %, preferably about 15 w/w % to about 30 w/w %; wherein the solvent is benzene; wherein concentration of the said metal halide is ranging from about 43 w/w % to about 65 w/w %; and wherein the metal of the metal halide is selected from group comprising aluminium, iron, zinc, manganese, magnesium, titanium, tin, palladium, platinum, rhodium, copper, chromium, cobalt, cerium, nickel, gallium, indium, antimony and zirconium or any combination thereof; and the halogen of the metal halide is selected from group comprising fluorine, chlorine, bromine, iodine and astatine or any combination thereof.

11. The system as claimed in claim 2, wherein the system is operational in mode selected from group comprising batch mode, semi-continuous mode and continuous mode, or any combination thereof; the mixing unit (101) is selected from group comprising stirred vessel, static mixer, jet mixer and pump mixer, or any combination thereof; the first reactor (102) is selected from group comprising stirred tank reactor and static mixer or combination thereof; the solid separation unit (103) is selected from group comprising filter, centrifuge, pressure nutsche filter, agitated nutsche filter, vacuum filter and filter-dryer combination such as agitated nutsche filter dryer or any combination thereof; the evaporator (105) is selected from group comprising single effect evaporator, multiple effect evaporator, falling film evaporator, agitated thin film evaporator and evaporator-dryer combination or any combination thereof; wherein the dryer is selected from group comprising tray-dryer and agitated thin film dryer or combination thereof; the distillation unit (104) is selected from group comprising single stage tray column, multi stage tray column, packed column and falling film evaporator or any combination thereof; and the second reactor (106) is selected from group comprising stirred tank reactor and static mixer or combination thereof.

12. The method as claimed in claim 3, wherein the mixing unit (101) is selected from group comprising stirred vessel, static mixer, jet mixer and pump mixer, or any combination thereof; the first reactor (102) is selected from group comprising stirred tank reactor and static mixer or combination thereof; the solid separation unit (103) is selected from group comprising filter, centrifuge, pressure nutsche filter, agitated nutsche filter, vacuum filter and filter-dryer combination such as agitated nutsche filter dryer or any combination thereof; the evaporator (105) is selected from group comprising single effect evaporator, multiple effect evaporator, falling film evaporator, agitated thin film evaporator and evaporator-dryer combination or any combination thereof; wherein the dryer is selected from group comprising tray-dryer and agitated thin film dryer or combination thereof; the distillation unit (104) is selected from group comprising single stage tray column, multi stage tray column, packed column and falling film evaporator or any combination thereof; and the second reactor (106) is selected from group comprising stirred tank reactor and static mixer or combination thereof.

13. The system as claimed in claim 2, wherein the mixture comprising spent ionic liquid and compound containing at least one coordinating agent is at a temperature ranging from about −5° C. to about 50° C., preferably about 20° C. to about 30° C., for a time period ranging from about 0.5 hour to about 3 hours, preferably about 2.5 hours to about 3 hours; wherein the adduct is subjected to washing with solvent; wherein the said solvent for washing is selected from group comprising secondary alcohol, aromatic alcohol, phenol, ketone, hydrocarbon, ethyl acetate, acetonitrile and dichloromethane or any combination thereof; wherein amount of the said solvent is ranging from about 0 g to about 100 g, preferably from about 25 g to about 75 g; and wherein the filtered adduct obtained in step c) comprises the adduct formed between the ionic liquid and the coordinating agent.

14. The system as claimed in claim 2, wherein the system comprises a mixing unit (101) fluidly connected to the at least one first reactor (102), wherein the mixing unit is configured to mix the spent ionic liquid with solvent before supplying to the at least one first reactor (102); wherein the system comprises at least one distillation unit (104) fluidly connected to the at least one solid separation unit, wherein the at least one distillation unit (104) is configured to distil out solvent and the compound containing at least one co-ordinating agent from the filtrate; wherein the filtrate comprises solvent, compound containing at least one coordinating agent or impurity or any combination thereof; and wherein the filtrate is present in a form selected from group comprising solid, liquid and gas or any combination thereof.

15. The system as claimed in claim 2, wherein the system comprises a fluid flow passage connected between compound containing at least one coordinating agent flow stream and at least one of the distillation unit (104) or the at least one evaporator (105) or combination thereof, for recycling the compound containing at least one coordinating agent to the at least one first reactor; wherein the system comprises fluid bypass passage connected between compound containing at least one coordinating agent flow stream and the at least one solid separation unit (103) for supplying the compound containing at least one coordinating agent; and wherein the system comprises bypass passage connected between compound flow stream and the at least one second reactor (106) for recovering the ionic liquid, wherein the said compound is selected from group comprising solvent or metal halide or a combination thereof.

16. The method as claimed in claim 3, wherein the spent ionic liquid is mixed with solvent in mixing unit (101) prior to adding to the first reactor (102); wherein the filtrate obtained in step c) is subjected to distillation unit (104) to distil out the solvent or the compound containing at least one coordinating agent or combination thereof; wherein the recovered ionic liquid of step d) is contacted with compound selected from group comprising solvent and metal halide or combination thereof; and wherein the filtrate comprises solvent, compound containing at least one coordinating agent or impurity or any combination thereof; and wherein the filtrate is present in a form selected from group comprising solid, liquid and gas or any combination thereof.

17. The system as claimed in claim 2, wherein the adduct is formed between the ionic liquid and the compound containing at least one coordinating agent; wherein the recovery of the ionic liquid is carried out under inert atmosphere; wherein the inert atmosphere is N2 atmosphere; wherein the ionic liquid is selected from group comprising phosphonium based ionic liquid, ammonium based ionic liquid and metal based ionic liquid or any combination thereof; and wherein amount of impurity present in the spent ionic liquid is ranging from about 10 w/w % to about 50 w/w %, preferably from about 20 w/w % to about 30 w/w %.

18. The system as claimed in claim 2, wherein the compound containing at least one coordinating agent is selected from group comprising secondary alcohol, aromatic alcohol, phenol and ketone or any combination thereof; wherein the secondary alcohol is selected from group comprising isopropanol or 2-butanol or combination thereof, preferably isopropanol, the aromatic alcohol is 1-phenylethanol and the ketone is acetone; wherein ratio of the concentration of compound containing at least one coordinating agent to that of metal halide of the ionic liquid is ranging from about 1:1 to about 1:18 mole, preferably about 1:3 to about 1:6 mole ratio; wherein the solvent is selected from group comprising hydrocarbon, ethyl acetate, acetonitrile and dichloromethane or any combination thereof; wherein the hydrocarbon solvent is selected from group comprising benzene, pentane, hexane, heptane, octane, nonane and decane, or any combination thereof, preferably hexane; and wherein ratio of the amount of the solvent to that of the spent ionic liquid is ranging from about 0.5:1 to about 10:1, preferably from about 1:1 to about 4:1.

19. The method as claimed in claim 3, wherein the compound containing at least one coordinating agent is selected from group comprising secondary alcohol, aromatic alcohol, phenol and ketone or any combination thereof; wherein the secondary alcohol is selected from group comprising isopropanol or 2-butanol or combination thereof, preferably isopropanol, the aromatic alcohol is 1-phenylethanol and the ketone is acetone; wherein ratio of the concentration of compound containing at least one coordinating agent to that of metal halide of the ionic liquid is ranging from about 1:1 to about 1:18 mole, preferably about 1:3 to about 1:6 mole ratio; wherein the solvent is selected from group comprising hydrocarbon, ethyl acetate, acetonitrile and dichloromethane or any combination thereof; wherein the hydrocarbon solvent is selected from group comprising benzene, pentane, hexane, heptane, octane, nonane and decane, or any combination thereof, preferably hexane; and wherein ratio of the amount of the solvent to that of the spent ionic liquid is ranging from about 0.5:1 to about 10:1, preferably from about 1:1 to about 4:1.

20. The method as claimed in claim 3, wherein the mixture comprising spent ionic liquid and compound containing at least one coordinating agent is at a temperature ranging from about −5° C. to about 50° C., preferably about 20° C. to about 30° C., for a time period ranging from about 0.5 hour to about 3 hours, preferably about 2.5 hours to about 3 hours; wherein the adduct is subjected to washing with solvent; wherein the said solvent for washing is selected from group comprising secondary alcohol, aromatic alcohol, phenol, ketone, hydrocarbon, ethyl acetate, acetonitrile and dichloromethane or any combination thereof; wherein amount of the said solvent is ranging from about 0 g to about 100 g, preferably from about 25 g to about 75 g; and wherein the filtered adduct obtained in step c) comprises the adduct formed between the ionic liquid and the coordinating agent.
